(19) United States
(12) Patent Application Publication
(10) Pub. No.: US 2018/0189019 A1
(43) Pub. Date: Jul. 5, 2018

(54) Mobile device case with embedded audio D/A converter, amplifier and supplemental circuitry

(71) Applicants: Peter Alf Joakim Fornell, Los Angeles, CA (US); Peter Griffin Oskar Fornell, Los Angeles, CA (US)

(72) Inventors: Peter Alf Joakim Fornell, Los Angeles, CA (US); Peter Griffin Oskar Fornell, Los Angeles, CA (US)

(21) Appl. No.: 15/396,631

(22) Filed: Dec. 31, 2016

(51) Int. Cl. G06F 3/16; G10K 11/178; H04R 3/00

(52) U.S. Cl. CPC G06F 3/162; G10K 11/1782; H04R 2499/11; H04R 3/00; G06F 3/165

(57) ABSTRACT

The Invention is the combination of a case that couples to a mobile device, digital-to-analog audio conversion and amplification circuitry and necessary control and communication functions to provide an enhanced listening experience using traditional analog headsets or speakers.

### CROSS REFERENCE TO RELATED APPLICATION

This application claims the benefit of U.S. Provisional Application No. 62/276,902 filed on Jan. 10, 2016, entitled “Mobile device case or accessory with built in audio amplifier and supplemental circuitry”. The above identified patent application is herein incorporated by reference in its entirety to provide continuity of disclosure.

### BACKGROUND OF THE INVENTION

Listening to music (as well as other audio experiences, by way of example audio books, podcasts, streaming content, etc.) has made a significant shift from stationary equipment to portable devices. With data speeds increasing, in particular for mobile phones, price of storage decreasing, audio products being available in lossless and high definition formats and consumers demanding better audio experiences, the weak link in quality for portable audio has become the audio converters of the listening device (by way of examples, such device could be a mobile phone, a tablet or other similar portable devices). The Invention solves this problem by extracting the audio content in its digital format from the portable device, to avoid the device's converters to degrade the content, and using high-quality converters and amplifiers to provide the Consumer with the ability to listen to high quality audio, whether through headphones or other devices such as speakers. It also solve the issue with some portable devices not having an analog output, requiring the consumer to replace their headsets or use a dongle converter. As consumers demand convenience and technological transparency, the invention is a combination of audio circuitry in an attachable case that their listening device couples to mechanically and electrically. Such enclosure may also embed a battery to not drain the device's power.

### BRIEF SUMMARY OF THE INVENTION

The Invention is the combination of an attachable case, digital-to-analog audio conversion and amplification circuitry and necessary control and communication functions.

The Invention contains audio conversion and amplification circuitry embedded in an attachable case [the “Enclosure”] for portable devices such as cellular phones, tablets and the likes [the “Device”]. The Enclosure contains digital-to-analog audio circuitry and an analog 3.5 mm jack, or other connector suitable for audio listening devices, and a method to connect to the Device to extract the audio in it's digital format. Such connector, by way of example, can be an Apple Lightning connector, a miniUSB or a USB-C connector as well as short-range or near-field wireless technologies [the “Connector”]. The Enclosure can also contain a battery to provide power to the audio circuitry in order to not drain the Device's internal battery. Such battery could also be used to power the Device when it's internal battery is low. The Invention can also contain a microphone(s) and related circuitry and functions to perform noise cancelling functions, to minimize ambient noise that can interfere and degrade the listening experience without the need to have special headphones with such circuitry.

The Enclosure can be any formfactor and material based on consumer's preference, type and style of device, manufacturing methods, cost and other factors. The Consumer inserts their device into the Enclosure, which attaches to the Device in manner and methods similar to traditional device protective cases on the market presently, or in the future.

### BRIEF DESCRIPTION OF THE DRAWINGS

FIG. 1 is a front schematic perspective view of a cell phone case audio amplifying device according to an embodiment of the present invention.

FIG. 2 is a side schematic perspective view of a cell phone case audio amplifying device according to an embodiment of the present invention.

FIG. 3 is a block-diagram functional representation of the electronics circuitry according to an embodiment of the present invention.

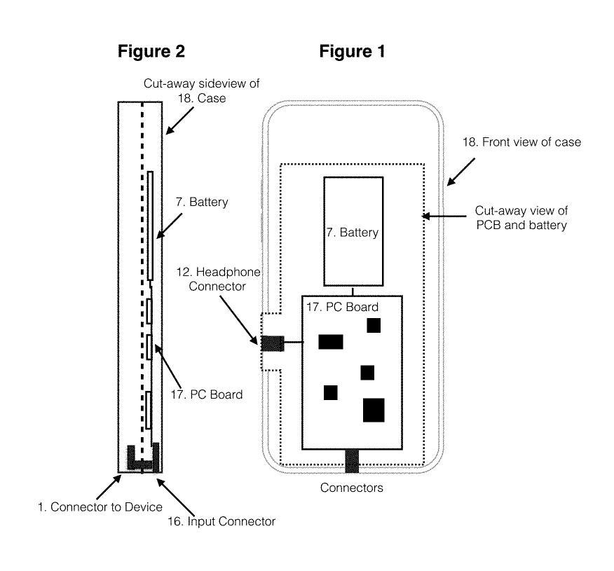

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, electrical, mechanical and other changes may be made without departing from the scope of the embodiments. The following detailed description is therefore not to be taken in a limiting sense. The enclosed diagrams and depictions are not intended to describe a physical partition or implementation, but rather major functional blocks. Such blocks may be implemented in hardware or software and any combination thereof.

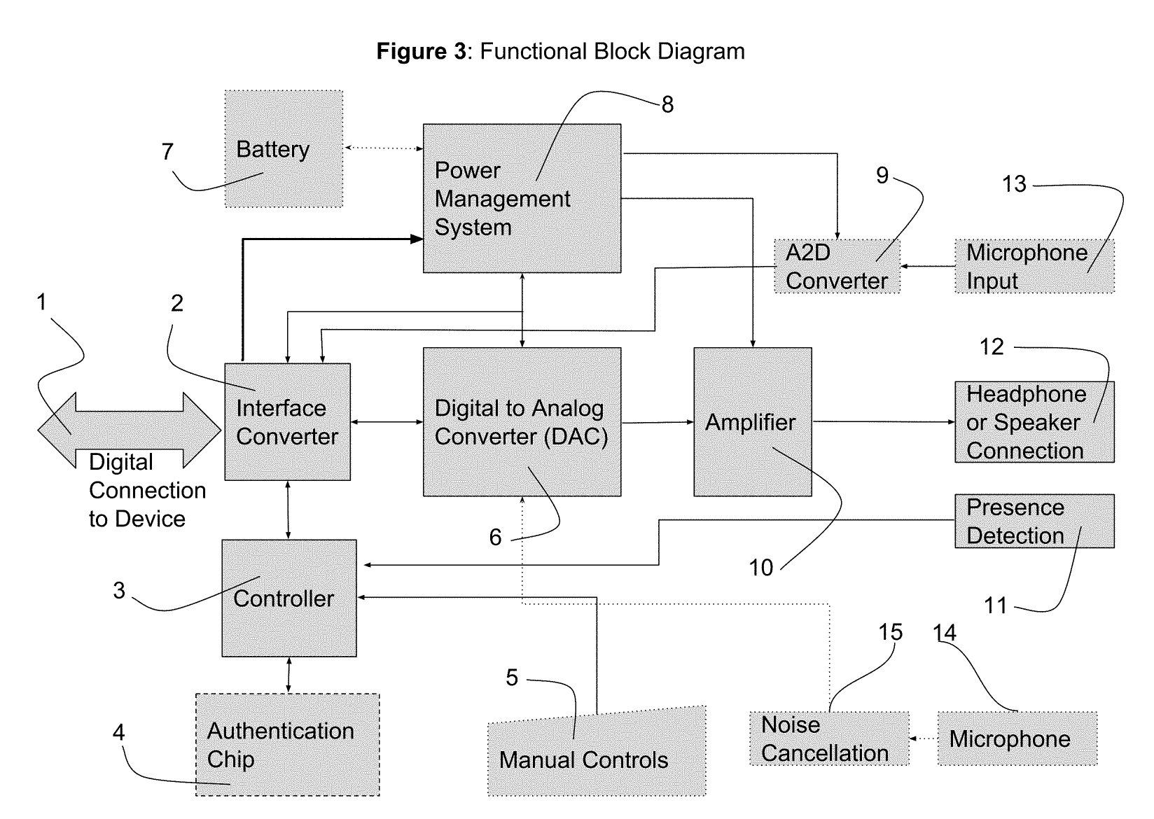

The block diagram [FIG. 3] depicts the major, high-level, functional blocks of the PCB [17] part of the Invention. The Invention connects to the Device through the Connector [1] that provides power and a bi-directional data connection to the Invention. The Invention instantiates itself to the Device as an audio end-point, such as a headset. When an audio connection is established, the Interface Converter [2] receives the audio stream and configuration information from the Device, according to the protocol used, and converts the source audio from the Device to an appropriate format, such as I2S, for the Digital-to-Analog Converter [6]. The Digital-to-Analog Converter [6] transforms the audio stream to analog signals for the Headset or Speaker Connection [12], whereas the Consumer's listening device, such as headphones, are connected.

The Controller [3] manages the circuitry, such as reads the [optional] user's Manual Controls [5], programs settings for the Digital-to-Analog Converter [6] that may be pre-programmed or received from the Device and commands, such as volume up, volume down and mute. The Controller [3] can also interface to a security chip [4] to provide authentication information. In case of using a headset, the Invention also contains a Presence Detection circuit [11] to know when the headset is connected, so that it can inform the Device that a headset is present (or not) for automatic routing of the audio stream and can include additional functions, such as Talk/End. Furthermore, when a headset is connected, the Invention can optionally include support for a microphone via appropriate pins in the headset connector [13] and an Analog-to-Digital Converter [9], to convert the analog microphone stream into the appropriate digital format for the Device.

The Power Management System [8] receives power from the Digital Connector [1] and converts it to the appropriate voltage for the components. Optionally, it can also support a Battery [7] by drawing power from it when appropriate, such as providing power to the Invention when the Device is not connected to a power source as to not deplete the Device's battery, as well as charging said battery when connected to power. If a sufficiently large battery is used, the Power Management System [8] can also provide power to the Device.

The [optional] microphone(s) [14] and noise cancellation function [15] combinedly provide the ability for suppressing ambient noises and sounds that may interfere with the content.

1. An attachable case to a portable device converting the device's digital audio to analog; comprising of an attachable case [18], a connector to the device [1], a connector for input and charging [16], a circuit board converting the device's digital audio to analog audio and amplifying such audio to the appropriate level and communicating commands and instructions to and from the device [17], wherein such circuit board and connectors are incorporated into the body of the case. An internal battery [7] coupled to the circuit board [16] can also provide power to the circuit board and to the device.

2. An attachable case [18] in claim 1, designed to hold a Device.

3. A printed circuit board [17] in claim 1, comprising of the circuits converting the digital audio to analog audio and amplifying such signal, as well as providing and accepting commands and control instructions to and from the Device per the Device's communication protocol.

4. A battery [7] in claim 1, providing power to the printed circuit board and with the ability of being re-charged when power is supplied to the Input Connect [16].

5. Whereas the input connector [16] in claim 1 provides a substitute for the device's digital and charging port.

6. Whereas the device connector [1] to the device in claim 1 couples the Invention to the device's digital port and power port

7. Whereas the headphone connector [12] allows the user to connect their existing headphone or speaker product to the Invention.

8. The electrical and mechanical parts of the Invention can be attached and incorporated into the case [18] using dual-injection molding, over molding, gluing or any other appropriate means.

9. Microphone(s) [14] and supporting circuitry [15] in claim 3 to suppress ambient noise from the audio stream, aka noise cancellation.
